(19) United States
(12) Patent Application Publication
(10) Pub. No.: US 2024/0106619 A1
(43) Pub. Date: Mar. 28, 2024

(54) SYSTEMS AND METHODS FOR PUBLIC CHANNELS AND SIGNALS

(71) Applicant: ZTE CORPORATION, Shenzhen (CN)

(72) Inventors: Kai XIAO, Shenzhen (CN); Wei GOU, Shenzhen (CN); Xianghui HAN, Shenzhen (CN)

(73) Assignee: ZTE CORPORATION, Shenzhen (CN)

(21) Appl. No.: 18/534,207

(22) Filed: Dec. 8, 2023

Related U.S. Application Data
(63) Continuation of application No. PCT/CN2022/080302, filed on Mar. 11, 2022.

(51) Int. Cl. H04L 5/18; H04L 5/00

(52) U.S. Cl. CPC H04L 5/18; H04L 5/0085; H04L 5/0096

(57) ABSTRACT

Presented are systems and methods for public channels and signals. A wireless communication node may determine a configuration for a resource configuration set scheduled in a cross-division duplex (XDD) slot, the configuration indicating that any one or more resource units of the resource configuration set that may overlap with a frequency band in the XDD slot that is of a different transmission direction as the resource configuration set, are to be remapped in a defined manner. The wireless communication node may send the configuration to a wireless communication device.

### CROSS-REFERENCE TO RELATED APPLICATION

This application claims the benefit of priority under 35 U.S.C. § 120 as a continuation of International Patent Application No. PCT/CN2022/080302, filed on Mar. 11, 2022, the disclosure of which is incorporated herein by reference in its entirety.

### TECHNICAL FIELD

The disclosure relates generally to wireless communications, including but not limited to systems and methods for public channels and signals.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the SGC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a non-transitory computer-readable medium for supporting and/or co-existence with public/common signal(s) and/or channel(s), for instance. In one embodiment, a wireless communication node (e.g., base station) may determine a configuration for a resource configuration set scheduled in a cross-division duplex (XDD) slot. In some embodiments, the configuration may indicate that any one or more resource units of the resource configuration set that may overlap with a frequency band in the XDD slot that is of a different transmission direction (e.g., downlink or uplink) as the resource configuration set. In certain embodiments, the one or more resource units of the resource configuration set can be to be remapped/re-scheduled in a defined matter. In some embodiments, the wireless communication node (e.g., base station) may send the configuration to a wireless communication device (e.g., user equipment). In some embodiments, the resource configuration set may include at least one of: a control resource set 0 (CORESET0), a downlink initial bandwidth part (BWP), an uplink initial BWP, a downlink BWP, or an uplink BWP. In some embodiments, each of the one or more resource units may comprise a resource element (RE), a resource block (RB), a RB group (RBG), a physical RB (PRB), or a control channel element (CCE).

In some embodiments, the configuration may indicate that all resource units of the resource configuration set or at least the one or more resource units of the resource configuration set that overlap with the frequency band, can be to be remapped to one or more other frequency bands in the XDD slot overlapping with the resource configuration set that are of a same transmission direction as the resource configuration set.

In some embodiments, the configuration may indicate that all resource units of the resource configuration set or at least the one or more resource units of the resource configuration set that overlap with the frequency band, can be to be remapped to one or more other frequency bands in the XDD slot that are of a same transmission direction as the resource configuration set.

In some embodiments, the configuration may indicate that the one or more resource units of the resource configuration set that overlap with the frequency band, can be to be remapped to one or more other frequency bands in the XDD slot that are of a same transmission direction as the resource configuration set, corresponding to a next available time domain region in the XDD slot.

In some embodiments, the configuration may indicate that all resource units of the resource configuration set can be to be remapped to a next available slot that is of a same transmission direction as the resource configuration set.

In some embodiments, the configuration may indicate that the one or more resource units of the resource configuration set that overlap with the frequency band, can be to be un-scheduled, or remapped to no region in the XDD slot.

In some embodiments, the wireless communication node (e.g., base station) may send an indication of a time duration and a transmission direction of the frequency band of the XDD slot to the wireless communication device (e.g., user equipment) via signaling. In some embodiments, the indication may include a bitmap of N bits, and T time domain units for the time duration that is partitioned into N groups corresponding to the N bits. In certain embodiments, each of the N bits may indicate a transmission direction of a corresponding one of the N groups. In some embodiments, N and T can be each a positive integer value.

In some embodiments, the indication further may include another bitmap of M bits, and F frequency domain units of the frequency band that is partitioned into M groups corresponding to the M bits. In some embodiments, each of the M bits may indicate a transmission direction of a corresponding one of the M groups. In some embodiments, M and F can be each a positive integer value.

In some embodiments, the indication may include N bits, and T time domain units for the time duration that is partitioned into G groups, and F frequency domain units. In some embodiments, each of G sets of bits from a most significant byte (MSB) of the N bits may have a one-to-one-mapping with the G groups. In some embodiments, N, T and G can be each a positive integer value.

In some embodiments, the indication may include N bits, and T time domain units for the time duration, and F frequency domain units for the frequency band that is partitioned into G groups. In some embodiments, each of G sets of bits from a most significant byte (MSB) of the N bits may have a one-to-one-mapping with the G groups. In some embodiments, N, T and G can be each a positive integer value.

At least one aspect is directed to a system, method, apparatus, or a non-transitory computer-readable medium. In some embodiments, a wireless communication device may receive a configuration from a wireless communication node (e.g., a ground terminal, a base station, a gNB, an eNB, or a serving node). In some embodiments, the configuration may be for a resource configuration set scheduled in a cross-division duplex (XDD) slot, and may indicate that one or more resource units of the resource configuration set that overlap with a frequency band in the XDD slot that is of a different transmission direction as the resource configuration set, can be to be remapped in a defined manner.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example cross-division duplex (XDD) slot, in accordance with some embodiments of the present disclosure;

FIG. 4 illustrates an example cross-division duplex (XDD) slot, in accordance with some embodiments of the present disclosure;

FIG. 5 illustrates an example cross-division duplex (XDD) slot, in accordance with some embodiments of the present disclosure;

FIG. 6 illustrates an example of a resource configuration set in a cross-division duplex (XDD) slot, in accordance with some embodiments of the present disclosure;

FIG. 7 illustrates an example of a resource configuration set in a cross-division duplex (XDD) slot, in accordance with some embodiments of the present disclosure;

FIG. 8 illustrates an example of a resource configuration set in a cross-division duplex (XDD) slot, in accordance with some embodiments of the present disclosure;

FIG. 9 illustrates an example of a resource configuration set in a cross-division duplex (XDD) slot, in accordance with some embodiments of the present disclosure;

FIG. 10 illustrates an example of a resource configuration set in a cross-division duplex (XDD) slot, in accordance with some embodiments of the present disclosure;

FIG. 11 illustrates an example of a resource configuration set in a cross-division duplex (XDD) slot, in accordance with some embodiments of the present disclosure;

FIG. 12 illustrates a flow diagram of an example method for supporting and/or coexistence with public channels and/or signals, in accordance with an embodiment of the present disclosure.

### DETAILED DESCRIPTION

### 1. Mobile Communication Technology and Environment

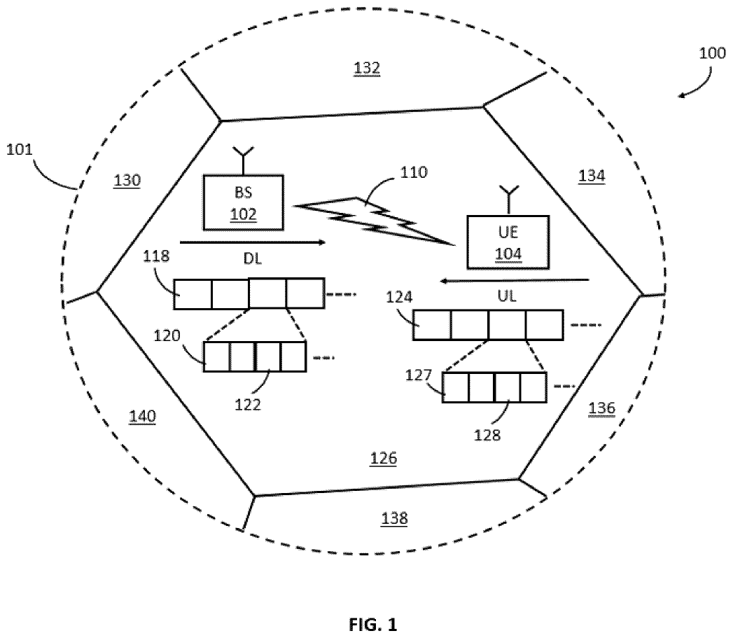

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

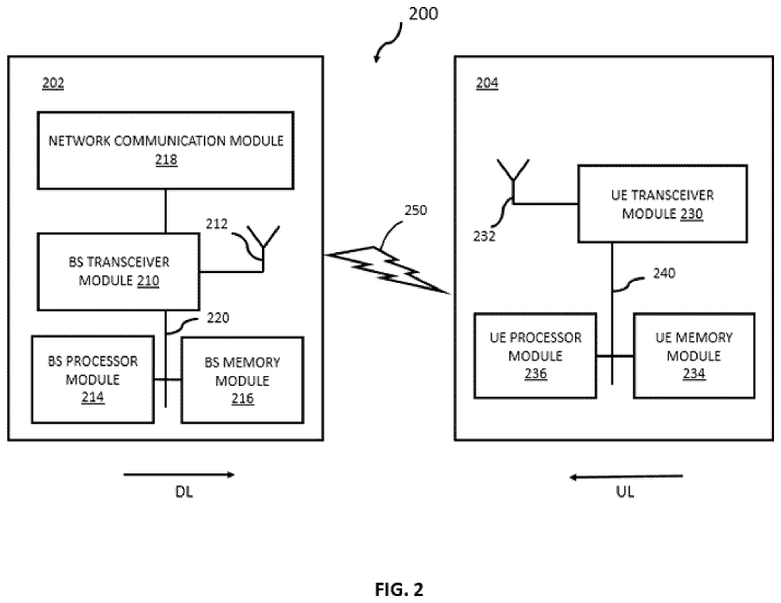

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Public Channels and Signals

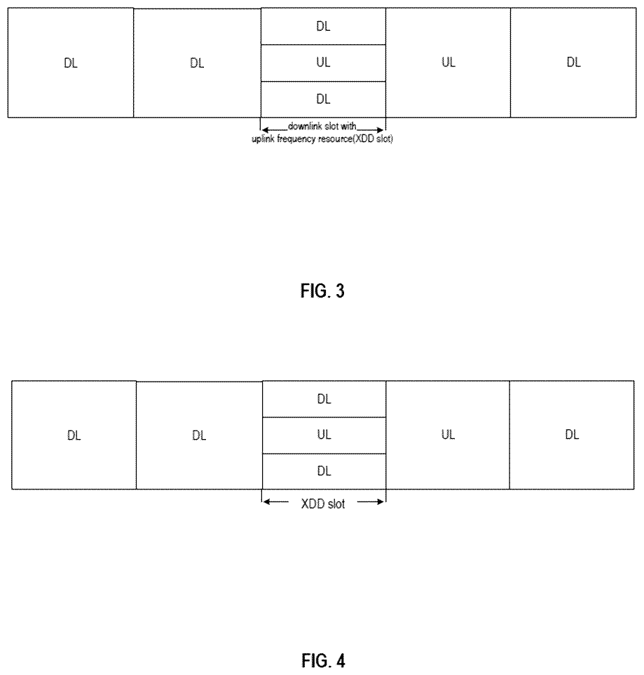

Wireless communication service is covering more and more application scenarios. Frequency division duplex (FDD) and time division duplex (TDD) are supported by fifth generation (5G) systems as two typical wireless frame structures. A gNB (base station) may simultaneously schedule uplink and downlink transmission in a FDD scenario. In certain embodiments, a gNB (base station) may simultaneously schedule only one type of transmission in a TDD scenario. When (e.g., in response to) a TDD wireless frame structure is configured and an uplink slot is far away from a downlink slot, a UE may not be able to provide feedback for a received physical downlink share channel (PDSCH) in time. In a TDD scenario, a timing gap (latency) between DL reception and UL transmission may be much larger than that in FDD. A full duplex (FD) XDD is initiated to solve/address such problem. By using the FD XDD at a base station, a UL and a DL signals can be received and transmitted on overlapping frequency resources. In a XDD scenario, a TDD slot can be configured with one type/direction (DL/UL) of resource for another type/direction (UL/DL) of transmission. For example (as shown in FIG. 3), a network may configure part of resource units in the frequency domain of a downlink TDD slot as an uplink frequency resource.

In a current 5G system, a control resource set for Type0 Physical Downlink Control Channel Common Search Space (CORESET for Type0-PDCCH CSS or CORESET0) bandwidth part (BWP) may occupy at least 24 resource blocks (RBs) in a frequency domain when a subcarrier spacing (SCS) is 15 kHz. The network may configure an initial downlink BWP so that the initial downlink BWP may contain an entire CORSET0 in a frequency domain. If a UE is not provided with an initial downlink BWP, an initial downlink BWP may be defined by a location and a number of contiguous physical resource blocks (PRBs). The number of contiguous PRBs may start from a PRB with the lowest index and may end at a PRB with the highest index among PRBs of a CORSET0.

Since bandwidth of some public/common channels or signals (e.g. control resource set for Type0 Physical Downlink Control Channel Common Search Space, CORESET for Type0-PDCCH CSS (CORSET0), downlink initial bandwidth part (BWP), or uplink initial BWP) cannot be dynamically configured, there may be a conflict between cross-division duplex (XDD) slot and some public channels and/or signals. Public/common channels or signals are used to communicate between a cell (BS) and one or more UEs. In some embodiments, a base station may cut off (e.g., allocated/reserved/configured) a large downlink (DL) bandwidth of a downlink slot to be used as an uplink (UL) bandwidth in a cross-division duplex (XDD) slot. In certain embodiments, a base station may cut off (e.g., allocated/reserved/configured) a large uplink (UL) bandwidth of an uplink slot to be used as a downlink (DL) bandwidth in a cross-division duplex (XDD) slot. Hence, how to protect the public channels/signals transmission in a XDD slot is a problem that the present disclosure recognizes and provides solutions to address. The systems and methods presented herein include a novel mechanism for frequency domain adjustment. Various aspects/features/elements from various examples/passages disclosed herein can be combined and/or re-ordered, in accordance with the present inventive concepts, and are in no way limited by the examples described herein.

### Example Implementation Aspects, Section 1

In some embodiments, a gNB (BS) can operate in full duplex mode, and a UE can operate in half duplex mode. The gNB (BS) can send a downlink transmission and can receive an uplink transmission at the same time. On the other hand, the UE can only send an uplink transmission or receive a downlink transmission at a point in time.

In some embodiments, a gNB (BS) can operate in full duplex mode, and a UE can operate in full duplex mode. The gNB (BS) can send a downlink transmission and can receive an uplink transmission at the same time. Also, the UE can send an uplink transmission and can receive a downlink transmission at a point in time (e.g., concurrently or at least partially overlapping in time).

Referring now to FIG. 4, in at least one XDD slot, some downlink bandwidth of a downlink slot is cut off (e.g., allocated/reserved/configured), by a BS, to be used as an uplink bandwidth. XDD is a duplexing method in which duplexing can be implemented in either a time domain, a frequency domain, or both domains within a single TDD carrier depending on needs/configuration/implementation. In FIG. 4, a BS may configure a TDD downlink bandwidth resource block for an uplink transmission. The illustrative XDD slot in FIG. 4 includes two downlink bandwidths (e.g., frequency subbands or bands) and one uplink bandwidth. In some embodiments, a XDD slot can include more than one uplink bandwidth. In some embodiments, a XDD slot can include more than three bandwidths. The present solution is not limited to the specific bandwidth order or number of bandwidths presented unless expressly stated otherwise. A gNB (BS) can schedule non-overlapping resources (in frequency domain) to cell-edge terminals (UEs) so that downlink and uplink transmissions may occur in/at the same time instance. In other words, a cell-edge terminal (UE) can assigned to transmit continuously on uplink resources while downlink transmissions are being made at a gNB side to serve other users (e.g., other UEs) at the same time.

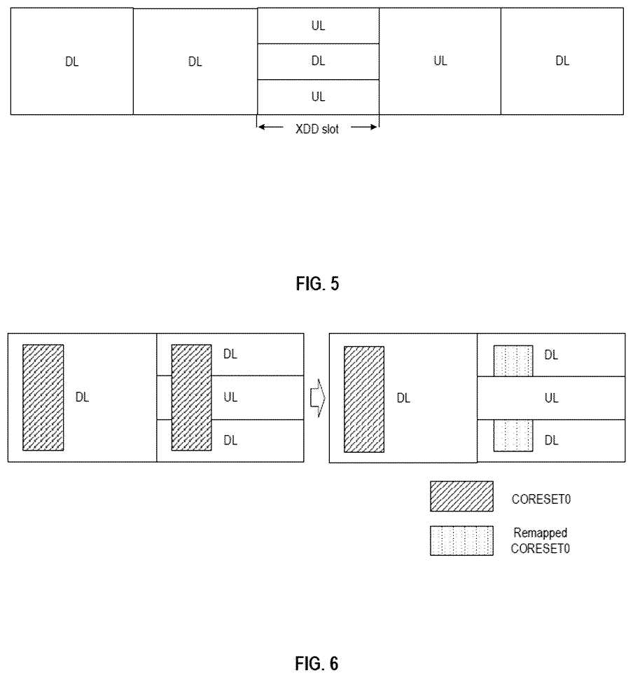

Referring now to FIG. 5, in at least one XDD slot, some uplink bandwidth (e.g., frequency subband or band) of an uplink slot is cut off (e.g., allocated/reserved/configured), by a BS, to be used as a downlink bandwidth. In FIG. 5, a BS may configure a TDD uplink bandwidth resource block for a downlink transmission. The example XDD slot in FIG. 5 includes two uplink bandwidths and one downlink bandwidth. In some embodiments, a XDD slot can include more than one downlink bandwidth. In some embodiments, a XDD slot can include more than three bandwidths. The present solution is not limited to the specific bandwidth order or number of bandwidths presented unless expressly stated otherwise. A gNB (BS) can schedule non-overlapping resources (in frequency domain) to cell-edge terminals (UEs) so that downlink and uplink transmissions may occur in the same time instance. In other words, a cell-edge terminal (UE) can be assigned to transmit continuously on uplink resources while downlink transmissions are being made at a gNB side to serve other users (e.g., other UEs) at the same time.

In some embodiments, a gNB (BS) can send at least one broadcast signal (e.g., secondary synchronization signal (SSS), primary synchronization signal (PSS), physical broadcast channel (PBCH)) at a certain period. After (e.g., in response to) a UE correctly decodes an information of the broadcast signal, a downlink transmission corresponding to a resource configuration set may be sent by the gNB, and/or an uplink transmission corresponding to a resource configuration set may be sent by the UE. The resource configuration set may include/be at least one of the following: a control resource set 0 (CORSET0), a downlink initial bandwidth part (BWP), an uplink initial BWP, a downlink BWP, or an uplink BWP. BWP configuration parameters may include numerology, frequency location, frequency band, bandwidth size, or control resource set (CORESET). An initial bandwidth part may be referred to by BandiwdthPartId=0. Initial BWP can be used to perform Initial Access Process.

At least one of the following configuration methods can be used to protect public channels and/or signals which are sent based on a resource configuration set, and public channels and/or signals which cannot be configured dynamically, and can be used to determine a new frequency domain adjustment mechanism.

### Example Method 1

A base station may schedule a resource configuration set in a downlink slot, an uplink slot, and/or a cross-division duplex (XDD) slot. When (e.g., in response to) a resource configuration set is scheduled in a XDD slot, resource units/elements of the resource configuration set may overlap with a frequency band in the XDD slot that is of a different transmission direction (sometimes referred to as transmission type) as the resource configuration set. When (e.g., in response to) the resource units/elements of the resource configuration set overlaps with a frequency band in the XDD slot that is of a different transmission direction as (a transmission direction of) the resource configuration set, the BS may remap (e.g., re-schedule, or re-allocate/re-assign/reconfigured the frequency-time locations of) the resource units/elements of the resource configuration set in a defined matter.

The resource units/elements of the resource configuration set may be remapped, by the BS, depending on available resources of the resource configuration set. The resource configuration set may include/be at least one of the following: a CORSET0, a downlink initial BWP, an uplink initial BWP, a downlink BWP, or an uplink BWP. The resource units/elements may be one of the following: a resource element (RE), a resource block (RB), a resource block group (RBG), a physical resource block (PRB), or a control channel element (CCE). A CORESET may be a set of physical resources within a specific area in Downlink Resource Grid and can be used to carry PDCCH (DCI). New radio (NR) PDCCHs are specifically designed to transmit in a configurable control resource set (CORESET). Frequency allocation in a CORESET configuration can be contiguous or non-contiguous. A special CORESET with index 0 (CORSET0) is defined, which can be configured using a (e.g., four-bit) information element in the master information block (MIB) with respect to the cell-defining synchronization signal and physical broadcast channel (PBCH) block (SSB).

Referring now to FIG. 6, a resource configuration set is a CORSET0. The CORSET0 may be set/located/scheduled in a downlink slot and a XDD slot. A BS may determine that a part/portion of the CORSET0 in the XDD slot is overlapping with an uplink bandwidth, which may be not able to transmit the part/portion of the CORSET0. The BS may determine that the remaining (non-overlapping with the uplink bandwidth) resources of the CORSET0 are available resource units/elements. The available resources in all the downlink bandwidth can be re-combined, by the BS, into a complete resource bandwidth, and control channel elements (CCEs) of the CORSET0 can be remapped, by the BS, to downlink bandwidth (the available resource units/elements) in the XDD slot overlapping with the CORSET0. The BS may send a configuration to a UE. The configuration may indicate that the resource units/elements of the CORSET0 that overlap with the uplink bandwidth. The resource units/elements are to be remapped, by the BS, to downlink bandwidth in the XDD slot overlapping with the CORSET0. The provided approach allows/enables/supports, in some embodiments, a BS to operate interleaving mapping properly and/or a UE to receive system information block #1 promptly.

### Example Method 2

A base station may schedule a resource configuration set in a downlink slot, an uplink slot, and/or a cross-division duplex (XDD) slot. When (e.g., in response to) a resource configuration set is scheduled in a XDD slot, resource units/elements of the resource configuration set may overlap with a frequency band in the XDD slot that is of a different transmission direction (or type) as the resource configuration set. When (e.g., in response to) the resource units/elements of the resource configuration set overlaps with a frequency band in the XDD slot that is of a different transmission direction as the resource configuration set, the BS may remap the resource units/elements of the resource configuration set in a defined matter.

The base station may perform frequency hopping (e.g., migration, re-location, or re-scheduling) of part or all resource units/elements of the resource configuration set, if part or all of the resource units/elements overlap with a bandwidth, when (e.g., in response to) the type/transmission direction (e.g., UL or DL) of the bandwidth is different from the type/transmission direction (e.g., DL or UL) of the resource configuration set. The resource configuration set may include/be at least one of the following: a CORSET0, a downlink initial BWP, an uplink initial BWP, a downlink BWP, or an uplink BWP. The resource units/elements may be one of the following: a RE, a RB, a RBG, a PRB, or a CCE.

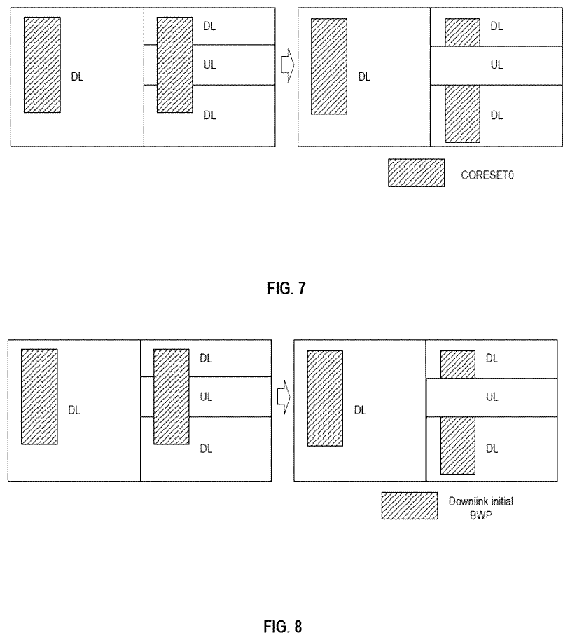

Referring now to FIG. 7, a resource configuration set can be a CORSET0. The CORSET0 may be set/located/scheduled in a downlink slot and a XDD slot. A BS may determine that a part/portion of the CORSET0 in the XDD slot is overlapping with an uplink bandwidth, which may not be able to transmit any portion of a CORSET0. The BS may determine that all control channel elements (CCEs) of the CORSET0 with at least a part overlapping with the uplink bandwidth can hop/migrate (or be remapped). Alternatively, the BS may determine that only a portion of the CCEs of the CORSET0 that overlaps with the uplink bandwidth can hop/migrate. The CCEs or part of the CCEs are to be remapped (hopped) to other downlink bandwidth in the XDD slot. The BS may send a configuration to a UE. The configuration may indicate that the resource units/elements of the CORSET0 that overlap with the uplink bandwidth. The resource units/elements are to be remapped (hopped), by the BS, to other downlink bandwidth in the XDD slot. Frequency hopping ensures that the CCEs can be mapped to the downlink bandwidth to the maximum extent. The provided approach allows/enables/supports a BS to operate/perform interleaving mapping properly, and/or a UE to receive system information block #1 promptly.

Referring now to FIG. 8, a resource configuration set can be a downlink initial BWP. The downlink initial BWP can be set/located/scheduled in a downlink slot and a XDD slot for instance. A BS may determine that a part/portion of the downlink initial BWP is overlapping with an uplink bandwidth, which may be not able to transmit a/any portion of a downlink initial BWP. The BS may determine that all resource blocks (RBs) of the downlink initial BWP with at least a part overlapping with the uplink bandwidth can hop. Alternatively, the BS may determine that only the portion of the RBs of the downlink initial BWP that overlaps with the uplink bandwidth can hop (e.g., can be re-mapped). The RBs or part of the RBs are to be remapped (hopped) to other downlink bandwidth in the XDD slot. The BS may send a configuration to a UE. The configuration may indicate that the resource units/elements of the downlink initial BWP that overlap with the uplink bandwidth (or all with at least a part overlapping with the uplink bandwidth) are to be remapped. The resource units/elements are to be remapped (hopped), by the BS, to other downlink bandwidth in the XDD slot. Frequency hopping ensures that the RBs are mapped to the downlink bandwidth to the maximum extent. The provided approach allows/enables/supports a BS to operate/perform interleaving mapping properly, and/or a UE to receive system information block #1 promptly.

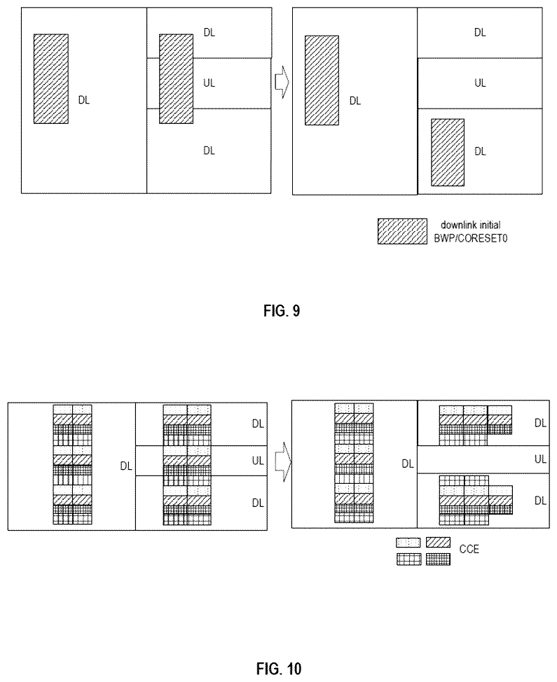

Referring now to FIG. 9, a resource configuration set is a CORSET0. The CORSET0 is set/located/scheduled in a downlink slot and a XDD slot. ABS may determine that a part/portion of the CORSET0 is overlapping with an uplink bandwidth, which may not be able to transmit a/any part of a CORSET0. The BS may determine that all control channel elements (CCEs) of the CORSET0 can hop/migrate (or be remapped). The CCEs are to be remapped (hopped) to other downlink bandwidth in the XDD slot. The BS may send a configuration to a UE. The configuration may indicate that the resource units/elements of the CORSET0 that overlap with (or all resource units/elements with at least a part of which overlaps with) the uplink bandwidth, are to be remapped. All of the resource units/elements of the CORSET0 are to be remapped (hopped), by the BS, to other downlink bandwidth in the XDD slot. Frequency hopping can ensure that the CCEs are mapped to the downlink bandwidth to the maximum extent. The provided approach allows/enables/supports a BS to operate/perform interleaving mapping properly, and/or a UE to receive system information block #1 promptly.

For example, as shown in FIG. 9, a resource configuration set can be a downlink initial BWP. The downlink initial BWP is set/located/scheduled in a downlink slot and a XDD slot. ABS may determine that a part/portion of the downlink initial BWP is overlapping with an uplink bandwidth, which may be not able to transmit a/any part of a downlink initial BWP. The BS may determine that all resource blocks (RBs) of the downlink initial BWP can hop. The RBs are to be remapped (hopped) to other downlink bandwidth in the XDD slot. The BS may send a configuration to a UE. The configuration may indicate that the resource units/elements of the downlink initial BWP that overlap with (or all resource units/elements with at least a part of which overlaps with) the uplink bandwidth are to be remapped. All of the resource units/elements of the downlink initial BWP are to be remapped (hopped), by the BS, to other downlink bandwidth in the XDD slot. Frequency hopping ensures that the RBs are mapped to the downlink bandwidth to the maximum extent. The provided approach allows/enables/supports a BS to operate/perform interleaving mapping properly (e.g., efficiently), and/or a UE to receive system information block #1 promptly.

### Example Method 3

A base station may schedule a resource configuration set in a downlink slot, an uplink slot, and/or a cross-division duplex (XDD) slot. When (e.g., in response to) a resource configuration set is scheduled in a XDD slot, resource units/elements of the resource configuration set may overlap with a frequency band in the XDD slot that is of a different transmission direction (e.g., downlink or uplink) as the resource configuration set. When (e.g., in response to) the resource units/elements of the resource configuration set overlaps with a frequency band in the XDD slot that is of a different transmission direction as the resource configuration set, the BS may remap the resource units/elements of the resource configuration set in a defined matter.

In some embodiments, a time domain symbol of a resource configuration set may be extended. The total number of resource units/elements may be not changed. The resource configuration set may include/be at least one of the following: a CORSET0, a downlink initial BWP, an uplink initial BWP, a downlink BWP, or an uplink BWP. The resource unit may comprise one of the following: a RE, a RB, a RBG, a PRB, or a CCE.

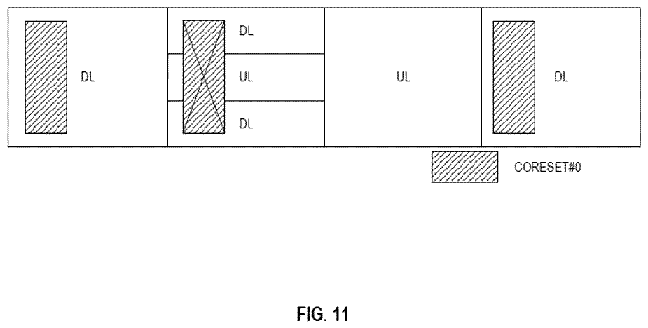

Referring now to FIG. 10, a resource configuration set can be a CORSET0. The CORSET0 can be set/located/scheduled in a downlink slot and a XDD slot. A BS may determine that a part/portion of the CORSET0 is overlapping with an uplink bandwidth, which may be not able to transmit a/any portion of a CORSET0. The BS may determine that the overlapping part/portion of CCEs of the CORSET0 can be moved to a frequency resource/band (downlink bandwidth) corresponding to the next available time domain symbol (e.g., the extended time domain region adjacent to non-remapped/occupied time domain region). The BS may send a configuration to a UE. The configuration may indicate that the resource units/elements of the CORSET0 that overlap with the uplink bandwidth, are to be remapped. The overlapping resource units/elements of the CORSET0 are to be remapped, by the BS, to other downlink bandwidth corresponding to the next available time domain symbol in the XDD slot. The provided approach allows/enables/supports a BS to operate/perform interleaving mapping properly, and/or a UE to receive system information block #1 promptly.

### Example Method 4

A base station may schedule a resource configuration set in a downlink slot, an uplink slot, and/or a cross-division duplex (XDD) slot. When (e.g., in response to) a resource configuration set is scheduled in a XDD slot, resource units/elements of the resource configuration set may overlap with a frequency band in the XDD slot that is of a different transmission direction (e.g., downlink or uplink) as the resource configuration set. When (e.g., in response to) the resource units/elements of the resource configuration set overlaps with a frequency band in the XDD slot that is of a different transmission direction as the resource configuration set, the BS may remap the resource units/elements of the resource configuration set in a defined matter.

In some embodiments, a resource configuration set can be postponed/delayed/moved to a closest/next available slot. The type (transmission direction) of the available slot can be the same type (e.g., transmission direction) of the resource configuration set. The resource configuration set may include/be at least one of the following: a CORSET0, a downlink initial BWP, an uplink initial BWP, a downlink BWP, or an uplink BWP. The resource unit may comprise one of the following: a RE, a RB, a RBG, a PRB, or a CCE. The transmission based on the resource configuration set can be either transmitted within the XDD slot, or not transmitted within the XDD slot. ABS may remap the resource configuration set to a next available slot of a same transmission direction as the resource configuration set.

Referring now to FIG. 11, a resource configuration set can be a CORSET0. The CORSET0 may be set/located/scheduled in a downlink slot and a XDD slot. A BS may determine that a part/portion of the CORSET0 is overlapping with an uplink bandwidth, which may not be able to transmit a CORSET0. A BS may remap/delay the COSESET0 to the closest/next available downlink slot. The BS may send a configuration to a UE. The configuration may indicate that the resource units/elements of the CORSET0 that overlap with the uplink bandwidth, are to be remapped. All of the resource units/elements of the CORSET0 are to be remapped (e.g., delayed in time), by the BS, to next available downlink slot. The provided approach allows/enables/supports a BS to increase the number of SS/PBCH blocks (SSBs) that can be configured, and/or to improve coverage. The provided approach can be applicable to legacy UEs (e.g., UEs that do not support XDD slots) or XDD UEs (e.g., UEs that support XDD slots).

### Method 5

A base station may schedule a resource configuration set in a downlink slot, an uplink slot, and/or a cross-division duplex (XDD) slot. When (e.g., in response to) a resource configuration set is scheduled in a XDD slot, resource units/elements of the resource configuration set may overlap with a frequency band in the XDD slot that is of a different transmission direction (e.g., downlink or uplink) as the resource configuration set. When (e.g., in response to) the resource units/elements of the resource configuration set overlaps with a frequency band in the XDD slot that is of a different transmission direction as the resource configuration set, the BS may remap the resource units/elements of the resource configuration set in a defined matter.

In some embodiments, part or all of resource units/elements of a resource configuration set may be punctured/dropped/un-scheduled/unmapped/unallocated (e.g., not transmitted or remapped to a region in a XDD slot, by a BS) if that part or all of the resource units/elements overlap with a type (transmission direction) of bandwidth that is different from the type (transmission direction) of the resource configuration set. The transmission based on the resource configuration set can be remapped to the remaining available resource units/elements, and a code rate can be improved/increased.

### Example Implementation Aspects, Section 2

In some embodiments, a gNB (BS) can operate in full duplex mode, and a UE can operate in half duplex mode. The gNB (BS) can send a downlink transmission and can receive an uplink transmission at the same time. On the other hand, the UE can only send an uplink transmission or receive a downlink transmission at a point in time.

In some embodiments, a gNB (BS) can operate in full duplex mode, and a UE can operate in full duplex mode. The gNB (BS) can send a downlink transmission and can receive an uplink transmission at the same time. Also, the UE can send an uplink transmission and may receive a downlink transmission at a (same) point in time.

In one example scenario, in at least one XDD slot, a large downlink bandwidth of a downlink slot is cut off (e.g., allocated/reserved/configured) to be used as an uplink bandwidth (as shown in FIG. 4).

In another example scenario, in at least one XDD slot, a large uplink bandwidth of an uplink slot is cut off (e.g., allocated/reserved/configured) to be used as a downlink bandwidth (as shown in FIG. 5).

In certain embodiments, a gNB (BS) may send an indication of a time duration and a transmission direction (e.g., type) of a frequency band of a XDD slot to a UE via a signaling (e.g., a radio resource control (RRC) signaling, a system information block (SIB) signaling). In some embodiments, a XDD pattern is more flexible in time domain. For example, a gNB (BS) may notify a UE of a bandwidth type (e.g., uplink bandwidth or downlink bandwidth) in a XDD slot via a RRC signaling and/or a dynamic signaling. At least one of the following methods can be used to determine and indicate a time duration and/or a transmission direction/type of a frequency band. The provided approach can be applicable to legacy UEs or XDD UEs. Various aspects/features/elements from various examples/passages disclosed herein can be combined and/or re-ordered, in accordance with the present inventive concepts, and are in no way limited by the examples described herein.

### Example Method 1

A gNB (BS) may send an indication of a time duration and a transmission direction (type) of a frequency band of a XDD slot to a UE via a signaling. The indication may include a bitmap of N bits, and T time domain units for the time duration. The time duration may be partitioned into N groups corresponding to the N bits. The gNB (BS) may configure a first bitmap into N bits. N is a number of bits of the first bitmap. T is a number of time domain units of the first bitmap. T can be divided into N groups. Each bit an include T/N time domain units. N bits may be in a one-to-one mapping with the N groups. N and T are each a positive integer value. A value of each bit may represent the type/transmission direction (e.g., 1=DL, 0=UL) of the corresponding group. The time domain unit can be one of the following: a time domain symbol, a mini-slot, or a slot. For instance, a time domain unit is a time domain symbol. If the value of a bit is ‘1’, the symbol of a corresponding group is a downlink symbol.

### Method 2

A gNB (BS) may send an indication of a time duration and a transmission direction (type) of a frequency band of a XDD slot to a UE via a signaling. The indication may include a first bitmap of N bits, and T time domain units for the time duration. The time duration can be partitioned into N groups corresponding to the N bits. The gNB (BS) may configure a first bitmap into N bits. N is a number of bits of the first bitmap. T is a number of time domain units of the first bitmap. T may be divided into N groups. Each bit can include T/N time domain units. N bits can be in a one-to-one mapping with the N groups. N and T are each a positive integer value. A value of each bit can represent the type/transmission direction (e.g., 1=DL, 0=UL) of the corresponding group. The time domain unit can be one of the following: a time domain symbol, a mini-slot, or a slot. The indication may include a second bitmap of M bits, and F frequency domain units of the frequency band. The frequency band can be partitioned into M groups corresponding to the M bits. The gNB (BS) may configure a second bitmap into M bits. F is a number of frequency domain units of the second bitmap. F may be divided into M groups. Each bit can include F/M frequency domain units. M bits may be in a one-to-one mapping with the M groups. M and F are each a positive integer value. A value of each bit may represent the type/transmission direction (e.g., 1=DL, 0=UL) of the corresponding group. The frequency domain unit can be one of the following: a PRB, a RB, a sub band, or a BWP. For instance, a time domain unit may be a time domain symbol, and a frequency domain unit can be a PRB. If the value of a bit is ‘1’, the symbol of a corresponding group is a downlink symbol. If the value of a bit of the first bitmap is ‘1’, the symbol of corresponding group is downlink symbol. If the value of a bit of the second bitmap is ‘1’, the PRB of corresponding group is a downlink PRB.

### Example Method 3

A gNB (BS) may send an indication of a time duration and a transmission direction (type) of a frequency band of a XDD slot to a UE via a signaling. The indication may include N bits, and T time domain units for the time duration that is partitioned into G groups, and F frequency domain units. The gNB (BS) may configure a number of bits into N bits. N is a number of bits. T is a number of time domain units. F is a number of frequency domain units. G is a number of partitions for the T time domain units. Each of G set of bits from a most significant byte (MSB) of the N bits can have a one-to-one mapping with the G groups of the time domain units. N, T, and G are each a positive integer value. Each of the first G−T+└T/G┘*G groups may include └T/G┘ time domain units. Each of the remaining T−└T/G┘*G groups may include ┌T/G┐ time domain units.

For a group of time domain units, M=N/G bits from the MSB of each set of bits can have a one-to-one mapping with M groups of frequency domain units. Each of the first M−F+└F/M┘*M groups may include └F/M┘ frequency domain units. Each of the remaining F−└F/M┘*M groups may include ┌F/M┐ frequency domain units.

A value of a bit may represent the type/transmission direction (e.g., 1=DL, 0=UL) of the corresponding group. The time domain unit can be one of the following: a time domain symbol, a mini-slot, or a slot. The frequency domain unit can be one of the following: a PRB, a RB, a sub band, or a BWP.

### Example Method 4

A gNB (BS) may send an indication of a time duration and a transmission direction (type) of a frequency band of a XDD slot to a UE via a signaling. The indication may include N bits, and T time domain units for the time duration, and F frequency domain units for the frequency band that is partitioned into G groups. The gNB (BS) may configure a number of bits into N bits. N is a number of bits. T is a number of time domain units. F is a number of frequency domain units. G is a number of partitions for the T time domain units. Each of G set of bits from a most significant byte (MSB) of the N bits may have a one-to-one mapping with the G groups of the time domain units. N, T, and G are each a positive integer value. Each of the first G−T+└T/G┘*G groups may include └T/G┘ frequency domain units. Each of the remaining T−└T/G┘*G groups may include ┌T/G┐ frequency domain units.

For a group of time domain units, M=N/G bits from MSB of each set of bits can have a one-to-one mapping with M groups of time domain units. Each of the first M−F+└F/M┘*M groups may include └F/M┘ time domain units. Each of the remaining F−└F/M┘*M groups may include ┌F/M┐ time domain units.

A value of a bit may represent the type/transmission direction (e.g., 1=DL, 0=UL) of the corresponding group. The time domain unit can be one of the following: a time domain symbol, a mini-slot, or a slot. The frequency domain unit can be one of the following: a PRB, a RB, a sub band, or a BWP.

An indication by a downlink control information (DCI) format for a serving cell may be applicable to a physical uplink shared channel (PUSCH) transmission, a physical downlink shared channel (PDSCH) transmission, or a sounding reference signal (SRS) transmission on a serving cell.

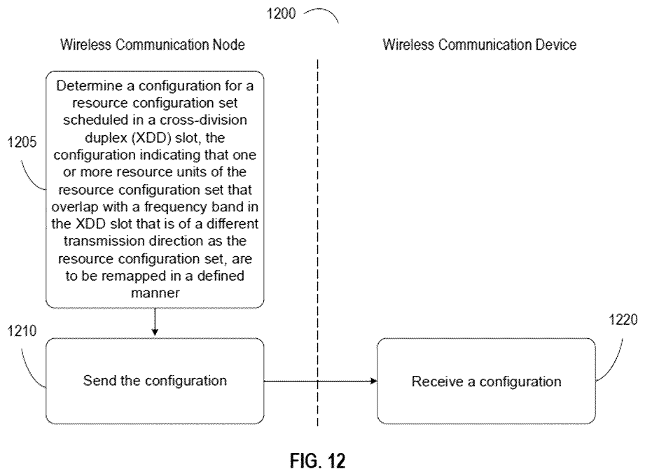

FIG. 12 illustrates a flow diagram of a method 1200 for public channels and signals. The method 1200 may be implemented using any of the components and devices detailed herein in conjunction with FIGS. 1-11. In overview, the method 1200 may include sending/receiving at least one message comprising a configuration for public channels and/or signals (1205).

Referring to (1205), and in some embodiments, a wireless communication node (e.g., gNB, base station) may determine a configuration for a resource configuration set (e.g., a CORSET0, a downlink initial BWP, an uplink initial BWP, a downlink BWP, an uplink BWP) scheduled/set/located in a cross-division duplex (XDD) slot. In some embodiments, the configuration may indicate that one or more resource units (e.g., a RE, a RB, a RBG, a PRB, a CCE) of the resource configuration set may overlap with a frequency band (e.g., frequency range or subband) in the XDD slot that is of a different transmission direction/type (e.g., downlink or uplink) as the resource configuration set. In certain embodiments, the any one or more resource units of the resource configuration set can be (or are to be) remapped/re-scheduled in a defined matter. In some embodiments, the wireless communication node (e.g., gNB, base station) may send the configuration to a wireless communication device (e.g., user equipment) (1210).

In some embodiments, the configuration may indicate that all resource units/elements (e.g., a RE, a RB, a RBG, a PRB, a CCE) of the resource configuration set (e.g., a CORSET0, a downlink initial BWP, an uplink initial BWP, a downlink BWP, an uplink BWP) or at least the one or more resource units/elements of the resource configuration set that overlap with the frequency band (e.g., DL bandwidth or UL bandwidth), can be (or are to be) remapped to one or more other frequency bands in the XDD slot overlapping with the resource configuration set that are of a same transmission direction/type as the resource configuration set.

In some embodiments, the configuration may indicate that all resource units/elements (e.g., a RE, a RB, a RBG, a PRB, a CCE) of the resource configuration set (e.g., a CORSET0, a downlink initial BWP, an uplink initial BWP, a downlink BWP, an uplink BWP) or at least the one or more resource units of the resource configuration set that overlap with the frequency band (e.g., DL bandwidth or UL bandwidth), can be (or are to be) remapped/hopped to one or more other frequency bands in the XDD slot that are of a same transmission direction/type as the resource configuration set.

In some embodiments, the configuration may indicate that the one or more resource units/elements (e.g., a RE, a RB, a RBG, a PRB, a CCE) of the resource configuration set (e.g., a CORSET0, a downlink initial BWP, an uplink initial BWP, a downlink BWP, an uplink BWP) that overlap with the frequency band (e.g., DL bandwidth or UL bandwidth), can be (or are to be) remapped/moved/rescheduled to one or more other frequency bands in the XDD slot that are of a same transmission direction/type as the resource configuration set, corresponding to a next available time domain region (e.g., an extended time domain region adjacent to non-remapped/occupied time domain region) in the XDD slot.

In some embodiments, the configuration may indicate that all resource units/elements (e.g., a RE, a RB, a RBG, a PRB, a CCE) of the resource configuration set (e.g., a CORSET0, a downlink initial BWP, an uplink initial BWP, a downlink BWP, an uplink BWP) can be (e.g., are to be) remapped/delayed to a next available slot that is of a same transmission direction/type as the resource configuration set.

In some embodiments, the configuration may indicate that the one or more resource units/elements (e.g., a RE, a RB, a RBG, a PRB, a CCE) of the resource configuration set (e.g., a CORSET0, a downlink initial BWP, an uplink initial BWP, a downlink BWP, an uplink BWP) that overlap with the frequency band, can be (e.g., are to be) punctured/dropped/unscheduled/unmapped/unallocated, or remapped to no region in the XDD slot.

In some embodiments, the wireless communication node (e.g., gNB, base station) may send an indication of a time duration and a transmission direction of the frequency band of the XDD slot to the wireless communication device (e.g., user equipment) via signaling (e.g., a radio resource control (RRC) signaling, a system information block (SIB) signaling). In some embodiments, the indication may include a bitmap/group of N bits, and T time domain units for the time duration that can be partitioned into N groups corresponding to the N bits. In certain embodiments, each of the N bits may indicate a transmission direction of a corresponding one of the N groups. In some embodiments, N and T can each be a positive integer value.

In some embodiments, the indication may further include another bitmap of M bits, and F frequency domain units of the frequency band that is partitioned into M groups corresponding to the M bits. In some embodiments, each of the M bits may indicate a transmission direction of a corresponding one of the M groups. In some embodiments, M and F can be each a positive integer value.

In some embodiments, the indication may include N bits, and T time domain units for the time duration that is partitioned into G groups, and F frequency domain units. In some embodiments, each of G sets of bits from a most significant byte (MSB) of the N bits may have a one-to-one-mapping with the G groups. In some embodiments, N, T and G can be each a positive integer value.

In some embodiments, the indication may include N bits, and T time domain units for the time duration, and F frequency domain units for the frequency band that is partitioned into G groups. In some embodiments, each of G sets of bits from a most significant byte (MSB) of the N bits may have a one-to-one-mapping with the G groups. In some embodiments, N, T and G can be each a positive integer value.

At least one aspect is directed to a system, method, apparatus, or a non-transitory computer-readable medium. In some embodiments, a wireless communication device (e.g., UE) may receive a configuration from a wireless communication node (e.g., a ground terminal, a base station, a gNB, an eNB, or a serving node) (1220). In some embodiments, the configuration may be for a resource configuration set scheduled in a cross-division duplex (XDD) slot, and may indicate that any one or more resource units of the resource configuration set that may overlap with a frequency band in the XDD slot that is of a different transmission direction as the resource configuration set, can be to be remapped in a defined manner.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a wireless communication node, a configuration for a resource configuration set scheduled in a cross-division duplex (XDD) slot, wherein one or more resource units of the resource configuration set that overlap with a frequency band in the XDD slot that is of a different transmission direction as the resource configuration set, are to be remapped or excluded in a defined manner; and
sending, by the wireless communication node to a wireless communication device, the configuration.

2. The method of claim 1, wherein the resource configuration set includes at least one of: a control resource set 0 (CORSET0), a downlink initial bandwidth part (BWP), an uplink initial BWP, a downlink BWP, or an uplink BWP.

3. The method of claim 1, wherein each of the one or more resource units comprises a resource element (RE), a resource block (RB), a RB group (RBG), a physical RB (PRB), or a control channel element (CCE).

4. The method of claim 1, wherein all resource units of the resource configuration set or at least the one or more resource units of the resource configuration set that overlap with the frequency band, are to be migrated or remapped to one or more other frequency bands in the XDD slot overlapping with the resource configuration set that are of a same transmission direction as the resource configuration set.

5. The method of claim 1, wherein all resource units of the resource configuration set or at least the one or more resource units of the resource configuration set that overlap with the frequency band, are to be migrated or remapped to one or more other frequency bands in the XDD slot that are of a same transmission direction as the resource configuration set.

6. The method of claim 1, wherein the one or more resource units of the resource configuration set that overlap with the frequency band, are to be migrated or remapped to one or more other frequency bands in the XDD slot that are of a same transmission direction as the resource configuration set, corresponding to a next available time domain region in the XDD slot.

7. The method of claim 1, wherein all resource units of the resource configuration set are to be migrated or remapped to a next available slot that is of a same transmission direction as the resource configuration set.

8. The method of claim 1, wherein the one or more resource units of the resource configuration set that overlap with the frequency band, are to be remapped or excluded, and a transmission based on the resource configuration set is mapped to remaining resource units of the resource configuration set.

9. The method of claim 1, comprising:
sending, by the wireless communication node to the wireless communication device via a signaling, an indication of a time duration and a transmission direction of the frequency band of the XDD slot.

10. The method of claim 9, wherein the indication includes a bitmap of N bits, and T time domain units for the time duration that is partitioned into N groups corresponding to the N bits,
where each of the N bits indicates a transmission direction of a corresponding one of the N groups, and
where N and T are each a positive integer value.

11. The method of claim 10, wherein the indication further includes another bitmap of M bits, and F frequency domain units of the frequency band that is partitioned into M groups corresponding to the M bits,
where each of the M bits indicates a transmission direction of a corresponding one of the M groups, and
where M and F are each a positive integer value.

12. The method of claim 9, wherein the indication includes N bits, and T time domain units for the time duration that is partitioned into G groups, and F frequency domain units,
where each of G sets of bits from a most significant byte (MSB) of the N bits have a one-to-one-mapping with the G groups, and
where N, T and G are each a positive integer value.

13. The method of claim 9, wherein the indication includes N bits, and T time domain units for the time duration, and F frequency domain units for the frequency band that is partitioned into G groups,
where each of G sets of bits from a most significant byte (MSB) of the N bits have a one-to-one-mapping with the G groups, and
where N, T and G are each a positive integer value.

14. The method of claim 1, wherein the one or more resource units of the resource configuration set are to be remapped or excluded according to an indication associated with the configuration.

15. A method comprising:
receiving, by a wireless communication device from a wireless communication node, a configuration,
wherein the configuration is for a resource configuration set scheduled in a cross-division duplex (XDD) slot, wherein one or more resource units of the resource configuration set that overlap with a frequency band in the XDD slot that is of a different transmission direction as the resource configuration set, are to be remapped or excluded in a defined manner.

16. A wireless communication node, comprising:
at least one processor configured to:
determine a configuration for a resource configuration set scheduled in a cross-division duplex (XDD) slot, wherein one or more resource units of the resource configuration set that overlap with a frequency band in the XDD slot that is of a different transmission direction as the resource configuration set, are to be remapped or excluded in a defined manner; and
send, via a transmitter to a wireless communication device, the configuration.

17. A wireless communication device, comprising:
at least one processor configured to:
receive, via a receiver from a wireless communication node, a configuration,
wherein the configuration is for a resource configuration set scheduled in a cross-division duplex (XDD) slot, wherein one or more resource units of the resource configuration set that overlap with a frequency band in the XDD slot that is of a different transmission direction as the resource configuration set, are to be remapped or excluded in a defined manner.

18. The wireless communication device of claim 17, wherein the resource configuration set includes at least one of: a control resource set 0 (CORSET0), a downlink initial bandwidth part (BWP), an uplink initial BWP, a downlink BWP, or an uplink BWP.

19. The wireless communication device of claim 17, wherein each of the one or more resource units comprises a resource element (RE), a resource block (RB), a RB group (RBG), a physical RB (PRB), or a control channel element (CCE).

20. The wireless communication device of claim 17, wherein all resource units of the resource configuration set or at least the one or more resource units of the resource configuration set that overlap with the frequency band, are to be migrated or remapped to one or more other frequency bands in the XDD slot overlapping with the resource configuration set that are of a same transmission direction as the resource configuration set.
